(19) United States
(12) Patent Application Publication
(10) Pub. No.: US 2026/0072778 A1
(43) Pub. Date: Mar. 12, 2026

(54) CONDITION MONITORING APPARATUS

(71) Applicant: Samsung Electronics Co., Ltd., Suwon-si (KR)

(72) Inventor: Minsung HA, Suwon-si (KR)

(73) Assignee: Samsung Electronics Co., Ltd., Suwon-si (KR)

(21) Appl. No.: 19/205,195

(22) Filed: May 12, 2025

(30) Foreign Application Priority Data
Sep. 12, 2024 (KR) 10-2024-0125133

(51) Int. Cl. G06F 11/07

(52) U.S. Cl. CPC G06F 11/079; G06F 11/0736

(57) ABSTRACT

A condition monitoring apparatus according to some example embodiments includes a memory configured to store stores a computer-readable program code, and a processor configured to execute the computer-readable program code. The processor is configured to encode monitoring data received from at least one sensor to obtain a first mean and a first standard deviation, sample the first mean and the first standard deviation to obtain a primary latent variable, perform a first decoding operation to reconstruct the primary latent variable to obtain first decoding data, encode the first decoding data to obtain a second mean and a second standard deviation, sample the second mean and the second standard deviation to obtain a secondary latent variable, and perform a second decoding operation to reconstruct the secondary latent variable to obtain second decoding data.

### CROSS-REFERENCE TO RELATED APPLICATION

This U.S. non-provisional application claims priority under 35 U.S.C. § 119 to Korean Patent Application No. 10-2024-0125133 filed in the Korean Intellectual Property Office on Sep. 12, 2024, the entire contents of which are incorporated herein by reference.

### BACKGROUND

Example embodiments relate to a condition monitoring apparatus.

When manufacturing a semiconductor device, various processes such as photolithography, etching, ashing, ion implantation, thin film deposition, and cleaning are performed on a substrate to form a desired pattern on the substrate. The etching process is a process of removing a selected region of a film formed on the substrate. The etching may include wet etching and dry etching.

One or more sensors sensor may be disposed in a substrate processing apparatus performing substrate processing. Each sensor detects an operational state of the substrate processing apparatus. Accordingly, based on the signals from the one or more sensors, it is possible to check whether the substrate processing apparatus is operating normally (e.g., as configured or desired) or whether an anomaly or undesirable operation has occurred in the substrate processing apparatus.

### SUMMARY

Example embodiments are directed to a condition monitoring apparatus that automatically monitors an operational state through a signal received from a sensor.

However, problems to be solved by the example embodiments are not limited to the above-described problem and may be variously extended in a range of technical ideas included in the present disclosure.

According to some example embodiments, a condition monitoring apparatus includes a memory configured to store a computer-readable program code, and a processor configured to execute the computer-readable program code. The computer-readable program code configures the processor to encode monitoring data received from at least one sensor to obtain a first mean and a first standard deviation, sample the first mean and the first standard deviation to obtain a primary latent variable, perform a first decoding operation to reconstruct the primary latent variable to obtain first decoding data, encode the first decoding data to obtain a second mean and a second standard deviation, sample the second mean and the second standard deviation to obtain a secondary latent variable, and perform a second decoding operation to reconstruct the secondary latent variable to obtain second decoding data.

According to some example embodiments, a condition monitoring apparatus includes a memory configured to store a computer-readable program code, and a processor configured to execute the computer-readable program code, wherein the computer-readable program code configures the processor to encode monitoring data to obtain a primary latent variable, perform a first decoding operation to reconstruct the primary latent variable to obtain first decoding data, encode the first decoding data to obtain a secondary latent variable, perform a second decoding operation to reconstruct the secondary latent variable to obtain second decoding data, encode the second decoding data to obtain a tertiary latent variable, and perform a third decoding operation to reconstruct the tertiary latent variable to obtain third decoding data.

According to some example embodiments, a condition monitoring apparatus includes a memory configured to store a computer-readable program code, and a processor configured to execute the computer-readable program code. The computer-readable program code configures the processor to encode monitoring data received from at least one sensor into a first mean and a first standard deviation, sample the first mean and the first standard deviation to obtain a primary latent variable, perform a first decoding operation to reconstruct the primary latent variable to obtain first decoding data, encode the first decoding data to obtain a second mean and a second standard deviation, sample the second mean and the second standard deviation to obtain a secondary latent variable, perform a second decoding operation to reconstruct the secondary latent variable to obtain second decoding data, encode the second decoding data to obtain a third mean and a third standard deviation, sample the third mean and the third standard deviation to obtain a tertiary latent variable, perform a third decoding operation to reconstruct the tertiary latent variable to obtain third decoding data, and calculate monitoring result data through an anomaly score that is based on the first decoding data, the second decoding data, and the third decoding data.

According to some example embodiments, a condition monitoring apparatus may be configured to automatically monitor an operational state through a signal received from a sensor.

### BRIEF DESCRIPTION OF THE DRAWINGS

FIG. 1 is a view showing a processing system, according to some example embodiments.

FIG. 2 illustrates a condition monitoring apparatus of FIG. 1.

FIG. 3 is a block diagram of a condition monitoring apparatus according to some example embodiments.

FIG. 4 illustrates a monitoring unit.

FIG. 5 illustrates a process in which the monitoring unit performs a primary training.

FIGS. 6, 7, and 8 illustrate a process in which the monitoring unit performs a secondary training.

FIGS. 9, 10, and 11 illustrate a process in which the monitoring unit monitors an operational state of a processing apparatus.

### DETAILED DESCRIPTION OF EXAMPLE EMBODIMENTS

Embodiments of the present disclosure will be described more fully hereinafter with reference to the accompanying drawings so that those skilled in the art could easily implement the embodiments. The present disclosure may be modified in various ways, all without departing from the spirit or scope of the present disclosure.

In order to clearly describe the present disclosure, parts or portions that are irrelevant to the description are omitted, and identical or similar constituent elements throughout the specification are denoted by the same reference numerals.

In the drawings, a size and a thickness of each element are arbitrarily illustrated for ease of description, and the present disclosure is not necessarily limited to those illustrated in the drawings. In the drawings, the thicknesses of some layers and areas are exaggerated for clarity. In the drawings, for ease of description, the thicknesses of some layers and areas are exaggerated.

It should be understood that when an element such as a layer, a film, a region, or a plate is referred to as being “on” or “above” another element, it may be directly on the other element, or an intervening element may also be present. In contrast, when an element is referred to as being “directly on” another element, there is no intervening element present. Further, in the specification, the word “on” or “above” means disposed on or below a referenced part, and does not necessarily mean disposed on the upper side of the referenced part based on a gravitational direction.

Unless explicitly stated to the contrary, the word “comprise” and variations such as “comprises” and “comprising” should be understood to imply the inclusion of stated elements but not the exclusion of any other elements.

Throughout the specification, the phrase “in a plan view” or “on a plane” may mean when an object portion is viewed from above, and the phrase “in a cross-sectional view” or “on a cross-section” may mean when a cross-section taken by vertically cutting an object portion is viewed from the side.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As used herein, to “monitor” is to watch, observe, or check something for a special or desired purpose over a period of time. The “monitoring” may occur periodically over the period of time, or the monitoring may occur continuously over the period of time.

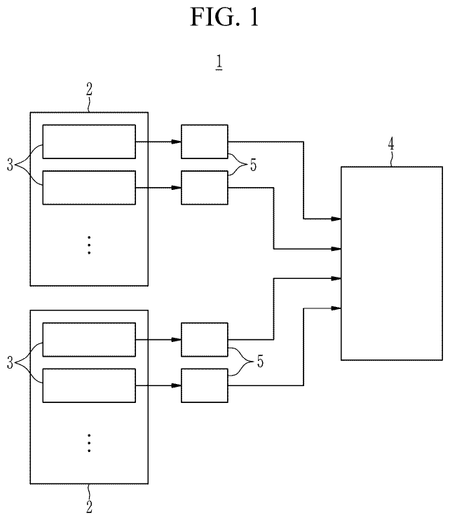

FIG. 1 illustrates a processing system 1, according to some example embodiments.

Referring to FIG. 1, the processing system 1, according to some example embodiments, may include a processing apparatus 2 and a condition monitoring apparatus 4.

The processing system 1 may perform predetermined or desired process. Additionally or alternatively, the processing system 1 may monitor whether an anomaly or undesired operation occurs (or has occurred) during the processing operations. For example, the processing system 1 may perform at least one process that may be performed for manufacturing a semiconductor device.

The processing apparatus 2 may perform a predetermined process on a substrate. The substrate may be a wafer or the like used for manufacturing the semiconductor device. For example, the processing apparatus 2 may be an equipment that performs a chemical mechanical polishing process, a photosensitive solution application process, an exposure process, a development process, an etching process, a deposition process, or the like on the substrate. The processing system 1 may include a plurality of processing apparatuses 2. Each processing apparatus 2 may perform a predetermined or desired operation on the substrate. Processing performed by the plurality of processing apparatuses 2 may be the same or different from each other.

Furthermore, manufacturing of the semiconductor device may include a packaging process for mounting a semiconductor device produced on a PCB and mold or encapsulate it with a molding material. Through the packaging process, semiconductor devices may be flipped or bonded onto a substrate using multiple contact members.

The processing apparatus 2 may include at least one sensor 3. The sensor 3 may detect an operational state of the processing apparatus 2. The sensor 3 may detect a process factor value that may affect a process result while the processing apparatus 2 performs the processing operation. In some example embodiments, the process factor value may be or include one or more of a pressure of a space or volume where the processing is performed, a temperature of the space or volume where the processing is performed, a humidity of the space or volume where the processing is performed, a state of plasma (e.g., a density of the plasma or an ion temperature (eV) of the plasma) of the space or volume where the processing is performed, a voltage supplied to a component of the processing apparatus 2, an electric current supplied to a component of the processing apparatus 2, electric power supplied to a component of the processing apparatus 2, a flow amount of fluid flowing inside the processing apparatus 2, a rotation speed of a component included in the processing apparatus 2 such as a motor, or the like. The sensor 3 may be or include a pressure sensor, a temperature sensor, a humidity sensor, a light detection sensor, a voltage meter, a current meter, an encoder, a torque sensor, and the like. The sensor 3 may detect the operational state of the processing apparatus 2 and transmit monitoring data that may be indicative of the operational state of the processing apparatus 2.

The condition monitoring apparatus 4 may monitor whether an anomaly or undesirable condition or operation occurs in the processing apparatus 2 based on the monitoring data transmitted from the sensor 3 of the processing apparatus 2. The condition monitoring apparatus 4 may be connected to the sensor 3 of the processing apparatus 2 via a wired network or wireless network. The sensor 3 of the processing apparatus 2 may be connected to the condition monitoring apparatus 4 via a preprocessor 5. For example, monitoring data output from a plurality of sensors 3 may have different scales or may be measured in different measurement units. The preprocessor 5 may perform scaling on the monitoring data received from the sensor 3 to output the scaled data to the condition monitoring apparatus 4. Accordingly, the monitoring data output from the plurality of sensors 3 may be input to the condition monitoring apparatus 4 in a state where they are adjusted to a scale corresponding to each other.

In some example embodiments, the condition monitoring apparatus 4 may be or include a computer. For example, the condition monitoring apparatus 4 may be or include a microcomputer, a minicomputer, a mainframe computer, or the like. Additionally or alternatively, the condition monitoring apparatus 4 may be implemented by a distributed computing system.

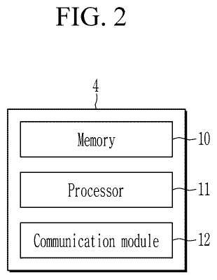

FIG. 2 illustrates an example condition monitoring apparatus 4 of FIG. 1.

Referring to FIG. 2, the condition monitoring apparatus 4 according to some example embodiments may include a memory 10, a processor 11, and a communication module 12.

The memory 10 may store data. The memory 10 may store a monitoring program (e.g., a computer-readable program code) for monitoring the operational state of the processing apparatus 1. The monitoring program may include sensor identification data for specifying or otherwise identifying the sensor 3 that transmitted the monitoring data. The sensor identification data may be data for distinguishing and identifying an individual sensor of the plurality of sensors 3 that transmitted the monitoring data. If the plurality of sensors 3 each transmit the monitoring data, each monitoring data may be matched one-to-one with each sensor 3 that transmitted each monitoring data by the sensor identification data. If there are a plurality of processing apparatuses 2, the sensor identification data may include data that may identify or specify the processing apparatus 2 among the plurality of processing apparatuses 2 in which the sensor 3 transmitting the monitoring data is installed. If the plurality of sensors 3 are provided in the processing apparatus 2, the sensor identification data may include data that may identify or specify a position or location of the sensor 3 in the processing apparatus 2.

The memory 10 may store monitoring result data generated in a process of performing the state monitoring. If the monitoring is performed, the monitoring result data may be generated periodically over time or may be generated over desired time intervals. The monitoring result data may include normal confirmation data and anomaly detection state data. The normal confirmation data may be data that are a result of monitoring the data received from the sensor 3 and may indicate that the processing apparatus 2 operates normally or desired. The anomaly detection state data may be data that is a result of monitoring the data received from the sensor 3 and may indicate that there is an anomaly or undesirable operation in the processing apparatus 2. Additionally or alternatively, the memory 10 may store the monitoring data received from the sensor 3. The memory 10 may include a random access memory (RAM) such as a dynamic random access memory (DRAM) or a static random access memory (SRAM), a read-only memory (ROM), an electrically erasable programmable read-only memory (EEPROM), a CD-ROM, a Blu-ray, an optical disk storage, a hard disk drive (HDD), a solid state drive (SSD), a flash memory, or the like.

The processor 11 may perform calculations to process data. The processor 11 may execute the monitoring program to receive the monitoring data from the sensor 3, and may perform calculations to process the monitoring data received from the sensor 3 to obtain the operational state of the processing apparatus 2. The processor 11 may input the monitoring data obtained to the monitoring program to output the monitoring result data. The processor 11 may perform one-to-one matching between the monitoring data received through the sensor identification data and the sensor 3 transmitting the monitoring data. The processor 11 may include a central processing unit (CPU), a graphics processing unit (GPU), an application processor (AP), or the like.

The processor 11 is configured to execute the monitoring program to implement the condition monitoring apparatus 4. In this way, processor 11 may be a special-purpose computer designed to implement the functions disclosed herein. The condition monitoring apparatus 4 is configured to operate as described with reference to FIGS. 1-11. For example, the processor 11 may be configured to perform at operations of the condition monitoring apparatus 4 and/or other tasks described herein.

The communication module 12 may transmit and receive data. The communication module 12 may be connected to one or more external systems through a wired network or a wireless network. The communication module 12 may receive the monitoring data. The communication module 12 may transmit the monitoring result data. For example, the communication module 12 may transmit the monitoring result data to the processing apparatus 2, a user terminal, and the like. The user terminal may be a personal computer (PC), a tablet PC, a smartphone, or the like. Any or all of the elements described with reference to FIG. 2 may communicate with any or all other elements described with reference to FIG. 2. For example, any element may engage in one-way and/or two-way and/or broadcast communication with any or all other elements in any of the figures, to transfer and/or exchange and/or receive information such as but not limited to data and/or commands, such as in a serial and/or parallel manner, via a bus such as a wireless and/or a wired bus. The information may be in encoded various formats, such as in an analog format and/or in a digital format, without being limited thereto.

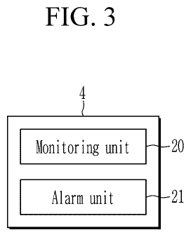

FIG. 3 is a block diagram of the condition monitoring apparatus 4, according to some example embodiments.

Referring to FIG. 3, the condition monitoring apparatus 4, according to some example embodiments, may include a monitoring unit (or a monitoring portion) 20 and an alarm unit (or an alarm portion) 21.

When the monitoring data are input, the monitoring unit 20 may perform calculations to process the monitoring data to detect the operational state of the processing apparatus 2. When the monitoring data are input, the monitoring unit 20 may perform the calculations to process the monitoring data to output the monitoring result data. When the normal or desired confirmation data is output, the monitoring unit 20 may determine that the operational state of the processing apparatus 2 is normal or as desired. When the anomaly or undesirable detection state data is output, the monitoring unit 20 may determine that there may be an anomaly or an undesirability in the operational state of the processing apparatus 2. The monitoring unit 20 may be implemented by the processor 11 executing the monitoring program. The processor 11 may execute the monitoring program that configures the processor 11 to operate an encoder 200 to perform one or more encoding operations, described below. Additionally or alternatively, the processor 11 may execute the monitoring program that configures the processor 11 to operate as decoders 231, 232, and 233 to perform one or more decoding operations, disclosed below. Additionally or alternatively, the processor 11 may execute the monitoring program that configures the processor 11 to perform one or more sampling operations described below.

The monitoring unit 20 may receive the monitoring data from the plurality of sensors 3, and may output the monitoring result data for each monitoring data. Additionally or alternatively, the monitoring unit 20 may match the sensor identification data with the monitoring result data. The monitoring unit 20 may calculate sensor specific data that may indicate or specify the sensor 3 among the plurality of sensors 3 that transmitted the monitoring data used to calculate the monitoring result data through the sensor identification data.

The alarm unit 21 may externally transmit the monitoring result data. Additionally or alternatively, the alarm unit 21 may transmit the sensor specific data together with the monitoring result data. For example, when the anomaly detection state data are output, the alarm unit 21 may transmit the anomaly detection state data to the processing apparatus 2, a user terminal, and the like. Additionally or alternatively, when the normal (or desired) confirmation data are output, the alarm unit 21 may transmit the normal confirmation data to the processing apparatus 2, the user terminal, and the like. The alarm unit 21 may be implemented by the processor 11 transmitting the monitoring result data through the communication module 12.

Any or all of the elements described with reference to FIG. 3 may communicate with any or all other elements described with reference to FIG. 3. For example, any element may engage in one-way and/or two-way and/or broadcast communication with any or all other elements in any of the figures, to transfer and/or exchange and/or receive information such as but not limited to data and/or commands, such as in a serial and/or parallel manner, via a bus such as a wireless and/or a wired bus. The information may be in encoded various formats, such as in an analog format and/or in a digital format, without being limited thereto.

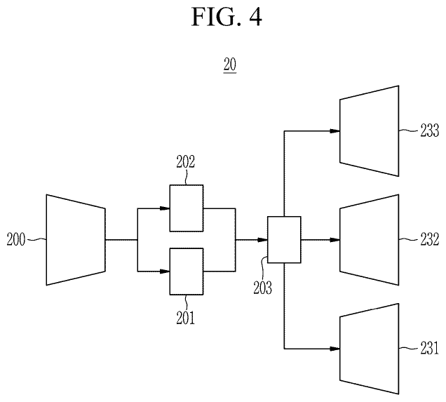

FIG. 4 illustrates a functional diagram of the monitoring unit 20 of FIG. 3.

Referring to FIG. 4, the monitoring unit 20 may include an encoder 200 and a plurality of decoders 231, 232, and 233.

The encoder 200 may compress or encode the input data into encoding data 201 and 202 having a smaller size than that of input data provided to the encoder 200.

For example, the input data may have a matrix structure. The encoding data 201 and 202 may have a structure in which at least one of a row and a column is reduced compared with that of the input data. The encoding data 201 and 202 may have a structure in which a row and a column are reduced compared to the input data. The encoder 200 may include at least one layer. Each layer of the encoder 200 may include at least one neuron. The encoding data 201 and 202 output from the encoder 200 may be considered a latent variable 203. In some example embodiments, the encoder 200 may compress the input data into the encoding data 201 and 202 including a mean (or an average) 201 and a standard deviation 202, respectively. Thereafter, the mean 201 and the standard deviation 202 may be converted into the latent variable 203 through latent space sampling. The encoder 200 may compress the input data to output the mean 201 and the standard deviation 202 of the latent variable 203. The mean 201 and the standard deviation 202 may be converted into the latent variable 203 through sampling. Training may be performed via a slope descent method, for example, using reparameterization trick of Equation 1 for the sampling for converting the mean 201 and the standard deviation 202 into the latent variable 203.

$$z = μ + {σ}^{2} \cdot ∈ \qquad [ Equation 1 ]$$

In Equation 1, z may be the latent variable 203, μ may be the mean 201, σ may be the standard deviation 202, and ε may be a noise sampled from a normal distribution with the mean 201 of 0 and the standard deviation 202 of 1.

Each of the plurality of decoders 231, 232, and 233 may convert the latent variable 203 into decoding data. The decoding data may be reconstructed (or decoded) to the same size as that of the input data input to the encoder 200 using the latent variable 203 as an input. The plurality of decoders 231, 232, and 233 may be in parallel with each other. The plurality of decoders 231, 232, and 233 may include the first decoder 231, the second decoder 232, and the third decoder 233. The first decoder 231 may perform reconstruction after the latent variable 203 is received to output first decoding data. The first decoder 231 may include at least one layer. Each layer of the first decoder 231 may include at least one neuron. The encoder 200 and the first decoder 231 may be referred to as a first autoencoder.

The second decoder 232 may perform reconstruction after the latent variable 203 is received to output second decoding data. The second decoder 232 may include at least one layer. Each layer of the second decoder 232 may include at least one neuron. The encoder 200 and the second decoder 232 may be referred to as a second autoencoder.

The third decoder 233 may perform reconstruction after the latent variable 203 is received to output third decoding data. The third decoder 233 may include at least one layer. Each layer of the third decoder 233 may include at least one neuron. The encoder 200 and the third decoder 233 may be referred to as a third autoencoder.

The monitoring unit 20 may include the first autoencoder, the second autoencoder, and the third autoencoder. The first autoencoder, the second autoencoder, and the third autoencoder may share one encoder 200. The first decoder 231 of the first autoencoder, the second decoder 232 of the second autoencoder, and the third decoder 233 of the third autoencoder may each be connected in series to an output of the encoder 200, and may have structures in parallel with each other.

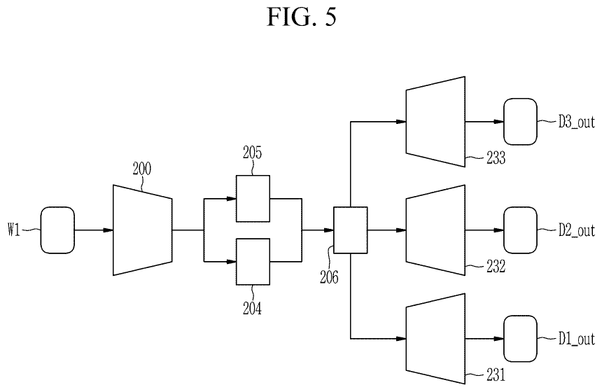

FIG. 5 illustrates a process in which the monitoring unit 20 of FIG. 3 performs a primary training, according to some example embodiments.

Referring to FIG. 5, the monitoring unit 20 may perform the primary training using primary training data W1. The primary training may be performed by the processor 11 executing the monitoring program using the primary training data W1 as an input.

The encoder 200 may compress the primary training data W1 that is provided as an input to the encoder 200 to generate a latent variable 206 by extracting a feature of the primary training data W1. The encoder 200 may compress the primary training data W1 into encoding data 204 and 205 including a mean 204 and a standard deviation 205, respectively.

The monitoring unit 20 may perform sampling to convert the mean 204 and the standard deviation 205 into the latent variable 206. In some example embodiments, the sampling process may be trained through a slope descent method using reparameterization trick.

The plurality of decoders 231, 232, and 233 may each reconstruct the latent variable 206 to output decoding data D1_out, D2_out, and D3_out, respectively.

The first decoder 231 may output the first decoding data D1_out reconstructed to the same size as that of the primary training data W1 using the latent variable 206 as an input. The encoder 200 and the first decoder 231 may perform training in a method in which a weight parameter is adjusted so that a loss function of the first decoding data D1_out and the primary training data W1 is reduced or minimized. The first autoencoder may perform training so that the loss function of the first decoding data D1_out and the primary training data W1 is reduced or minimized. In some example embodiments, a mean squared error, a mean absolute error, or the like may be used as the loss function. For example, the encoder 200 and the first decoder 231 may perform the training so that the loss function is reduced or minimized using a back-propagation technique. For example, the encoder 200 and the first decoder 231 may perform the training so that the loss function of Equation 2 is reduced or minimized. In Equation 2, W1 may be the primary training data, and D1_out may be the first decoding data.

$${‖ W 1 - D1\_out ‖}_{2} \qquad [ Equation 2 ]$$

The second decoder 232 may output the second decoding data D2_out reconstructed to the same size as that of the primary training data W1 using the latent variable 206 as an input. The encoder 200 and the second decoder 232 may perform training in a method in which a weight parameter is adjusted so that a loss function of the second decoding data D2_out and the primary training data W1 is reduced or minimized. The second autoencoder may perform training so that the loss function of the second decoding data D2_out and the primary training data W1 is reduced or minimized. In some example embodiments, a mean squared error, a mean absolute error, or the like may be used as the loss function. For example, the encoder 200 and the second decoder 232 may perform the training so that the loss function is reduced or minimized using a back-propagation technique. For example, the encoder 200 and the second decoder 232 may perform the training so that the loss function of Equation 3 is reduced or minimized. In Equation 3, W1 may be the primary training data, and D2_out may be the second decoding data.

$${‖ W 1 - D2\_out ‖}_{2} \qquad [ Equation 3 ]$$

The third decoder 233 may output the third decoding data D3_out reconstructed to the same size as that of the primary training data W1 using the latent variable 206 as an input. The encoder 200 and the third decoder 233 may perform training in a method in which a weight parameter is adjusted so that a loss function of the third decoding data D3_out and the primary training data W1 is reduced or minimized. The third autoencoder may perform training so that the loss function of the third decoding data D3_out and the primary training data W1 is reduced or minimized. In some example embodiments, a mean squared error, a mean absolute error, or the like may be used as the loss function. For example, the encoder 200 and the third decoder 233 may perform the training so that the loss function is reduced or minimized using a back-propagation technique. For example, the encoder 200 and the third decoder 233 may perform the training so that the loss function of Equation 4 is reduced or minimized. In Equation 4, W1 may represent the primary training data, and D3_out may represent the third decoding data.

$${‖ W 1 - D3\_out ‖}_{2} \qquad [ Equation 4 ]$$

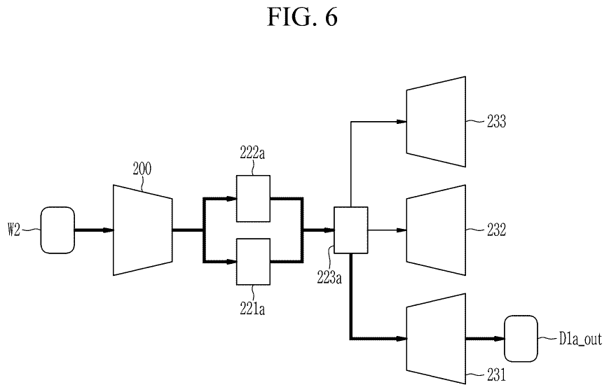

FIGS. 6 to 8 illustrate a process in which the monitoring unit 20 of FIG. 3 performs a secondary training, according to some example embodiments.

Referring to FIGS. 6 to 8, the monitoring unit 20 may perform the secondary training so that a plurality of autoencoders perform adversarial training through secondary training data W2. The secondary training may be performed after the primary training. The secondary training may be performed by the processor 11 executing the monitoring program using the secondary training data W2 as an input.

First, referring to FIG. 6, the encoder 200 may compress the secondary training data W2 that is provided as input to the encoder 200 to generate a primary latent variable 223a extracting a feature of the secondary training data W2.

The encoder 200 may compress the secondary training data W2 into encoding data 221a and 222a including a mean 221a and a standard deviation 222a, respectively.

The monitoring unit 20 may perform sampling to convert the mean 221a and the standard deviation 222a into the primary latent variable 223a. The sampling process may be trained through a slope descent method using reparameterization trick.

The first decoder 231 may output a first decoding data D1a_out reconstructed using the primary latent variable 223a generated from the secondary training data W2 as an input.

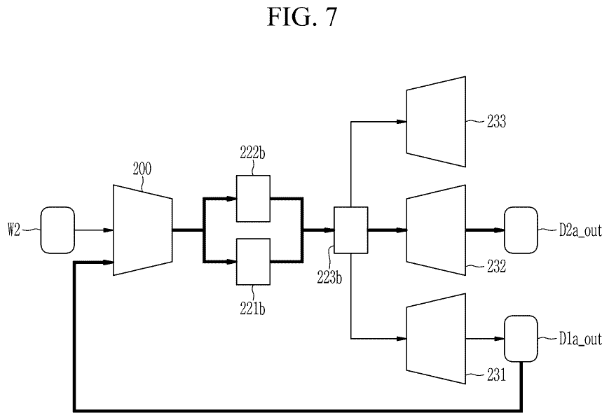

Referring to FIG. 7, the first decoding data D1a_out may be input (e.g., feedback) to the encoder 200. The encoder 200 may compress the first decoding data D1a_out to generate a secondary latent variable 223b extracting a feature of the first decoding data D1a_out.

The encoder 200 may compress the first decoding data D1a_out into encoding data 221b and 222b including a mean 221b and a standard deviation 222b, respectively.

The monitoring unit 20 may perform sampling to convert converting the mean 221b and the standard deviation 222b into the secondary latent variable 223b. The sampling process may be trained through a slope descent method using reparameterization trick.

The second decoder 232 may output a second decoding data D2a_out reconstructed using the secondary latent variable 223b generated from the first decoding data D1a_out as an input.

The first autoencoder and the second autoencoder may perform adversarial training with respect to each other. The first autoencoder may perform the training so that a loss function of Equation 5 is reduced or minimized. The first autoencoder may perform the training so that the loss function of Equation 5 is reduced or minimized. The second autoencoder may perform the training so that the loss function of Equation 5 is increased or maximized. The second autoencoder may perform the training so that the loss function of Equation 5 is increased or maximized. In Equation 5, W2 may represent the secondary training data, and D2a_out may represent the second decoding data.

$${‖ W 2 - D2a\_out ‖}_{2} \qquad [ Equation 5 ]$$

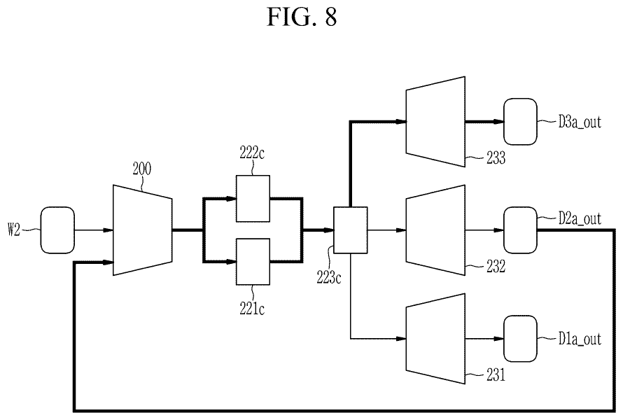

Referring to FIG. 8, the second decoding data D2a_out may be input (e.g., feedback) to the encoder 200. The encoder 200 may compress the second decoding data D2a_out to generate a tertiary latent variable 223c extracting a feature of the second decoding data D2a_out.

The encoder 200 may compress the second decoding data D2a_out into encoding data 221c and 222c including a mean 221c and a standard deviation 222c, respectively.

The monitoring unit 20 may perform sampling to convert the mean 221c and the standard deviation 222c into the tertiary latent variable 223c. The sampling process may be trained through a slope descent method using reparameterization trick.

The third decoder 233 may output a third decoding data D3a_out reconstructed using the tertiary latent variable 223c generated from the second decoding data D2a_out as an input.

The third autoencoder may perform training so that a loss function of Equation 6 is increased or maximized. The third autoencoder may perform the training so that the loss function of Equation 6 is increased or maximized. In Equation 6, W2 may represent the secondary training data, and D3a_out may represent the third decoding data.

$${‖ W 2 - D3a\_out ‖}_{2} \qquad [ Equation 6 ]$$

After the secondary training, the monitoring unit 20 may monitor the operational state of the processing apparatus 2 through the monitoring data transmitted from the sensor 3.

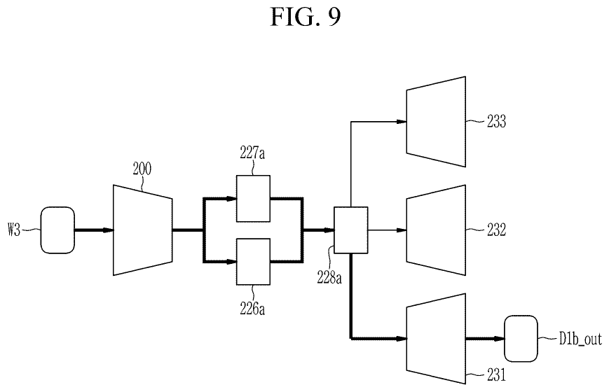

FIGS. 9 to 11 illustrate a process in which the monitoring unit 20 monitors the operational state of the processing apparatus 2.

First, referring to FIG. 9, the encoder 200 may compress (or encode) the monitoring data W3 that is received as input to generate a primary latent variable 228a extracting a feature of the monitoring data W3.

The encoder 200 may compress the monitoring data W3 into encoding data 226a and 227a including a mean 226a and a standard deviation 227a, respectively.

The monitoring unit 20 may perform sampling to convert the mean 226a and the standard deviation 227a into the primary latent variable 228a.

The first decoder 231 may output a first decoding data D1b_out that may be reconstructed using the primary latent variable 228a generated from the monitoring data W3 as an input.

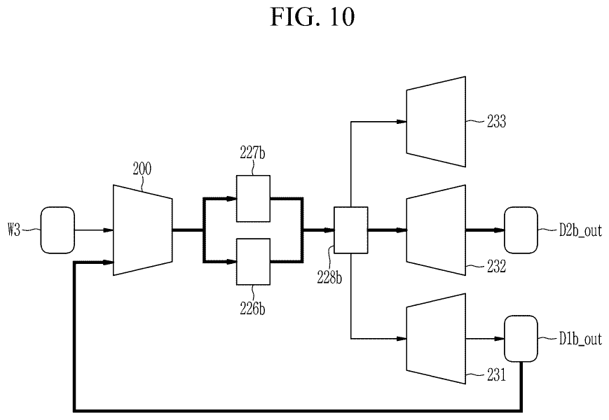

Referring to FIG. 10, the first decoding data D1b_out may be input (e.g., feedback) to the encoder 200. The encoder 200 may compress the first decoding data D1b_out to generate a secondary latent variable 228b extracting a feature of the first decoding data D1b_out.

The encoder 200 may compress the first decoding data D1b_out into encoding data 226b and 227b including a mean 226b and a standard deviation 227b, respectively.

The monitoring unit 20 may perform sampling to convert the mean 226b and the standard deviation 227b into the secondary latent variable 228b.

The second decoder 232 may output a second decoding data D2b_out reconstructed using the secondary latent variable 228b generated from the first decoding data D1b_out as an input.

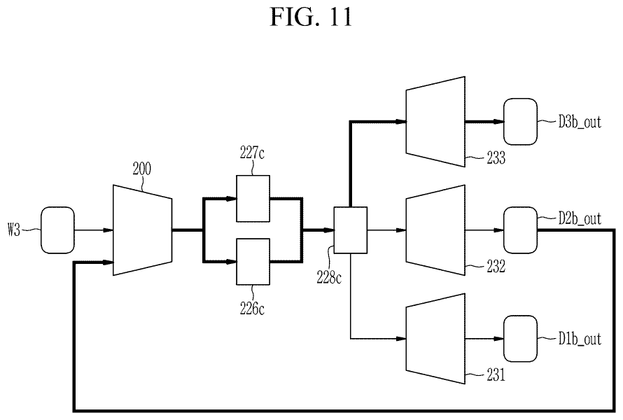

Referring to FIG. 11, the second decoding data D2b_out may be input (e.g., feedback) to the encoder 200. The encoder 200 may compress the second decoding data D2b_out to generate a tertiary latent variable 228c extracting a feature of the second decoding data D2b_out.

The encoder 200 may compress the second decoding data D2b_out into encoding data 226c and 227c including a mean 226c and a standard deviation 227c, respectively.

The monitoring unit 20 may perform sampling to convert the mean 226c and the standard deviation 227c into the tertiary latent variable 228c.

The third decoder 233 may output a third decoding data D3b_out reconstructed using the tertiary latent variable 228c generated from the second decoding data D2b_out as an input.

Thereafter, the monitoring unit 20 may calculate an anomaly score based on Equation 7. In Equation 7, D1b_out may represent the first decoding data, D2b_out may represent the second decoding data, and D3b_out may represent the third decoding data. In Equation 7, α, β, and γ may be parameters.

$$αD1b\_out + βD2b\_out + γD3b\_out \qquad [ Equation 7 ]$$

Additionally or alternatively, the monitoring unit 20 may calculate the monitoring result data through a value of the anomaly score. If the anomaly score is greater than or equal to a predetermined (or desired) value, the monitoring unit 20 may determine that an anomaly has occurred in the processing apparatus 2 that is a monitoring target. When the anomaly score is greater than or equal to the predetermined value, the monitoring unit 20 may output the anomaly detection state data, for example, indicative of an undesirable operational state. When the anomaly score is less than the predetermined (or desired) value, the monitoring unit 20 may determine that the operational state of the processing apparatus 2 that is the monitoring target is normal or desired. When the anomaly score is less than the predetermined value, the monitoring unit 20 may output the normal confirmation data.

Additionally or alternatively, if the anomaly score exceeds a predetermined value, the monitoring unit 20 may determine that an anomaly occurs in the processing apparatus 2 that is the monitoring target. When the anomaly score exceeds the predetermined value, the monitoring unit 20 may output the anomaly detection state data, for example, indicative of an undesirable operational state. When the anomaly score is less than or equal to the predetermined (or desired) value, the monitoring unit 20 may determine that the operational state of the processing apparatus 2 that is the monitoring target is normal or desired. When the anomaly score is less than or equal to the predetermined value, the monitoring unit 20 may output the normal confirmation data. In some example embodiments, based on the anomaly score, one or more corrective actions may be taken to remedy the anomaly that may have occurred in the processing apparatus 2. For example, using the monitoring data, the location of the anomaly in the processing apparatus 2 may be determined, and the appropriate corrective action may be taken so that the operational state of the processing apparatus 2 is restored to the normal or desired operational state. The appropriate corrective action may include servicing, repairing, or replacing the processing apparatus 2 that may have caused the anomaly to restore the processing apparatus to the normal or desired operational state.

The operational state of the processing apparatus 2 may be monitored by the sensor 3. The plurality of sensors 3 may be disposed in, around, or adjacent the processing apparatus 2. Each sensor 3 may be positioned or arranged at any desired location in, around, or adjacent the processing apparatus 2 provided the sensor 3 can monitor and/or measure the one or more parameters or process factors of the processing apparatus 2 that the sensor 3 is programmed or otherwise configured to monitor and/or measure. The process factors detected by the sensors 3 may be different from each other. Accordingly, different types of data may be output by the sensors 3.

A plurality of processing apparatuses 2 may be disposed in a semiconductor production facility. Accordingly, processes performed by the plurality of processing apparatuses 2 may be different from each other. Even if the processing apparatuses 2 perform the same process, recipes applied to the processing apparatuses 2 may be different from each other. Accordingly, types of the data output by the sensors 3 related to the processing apparatuses 2 may be different from each other.

Accordingly, if a worker analyzes the output data from each sensor 3 to determine whether there is an anomaly in the processing apparatus 2, the analysis may be time consuming, and multiple workers may perform the data analysis.

The condition monitoring apparatus 4 according to some example embodiments may automatically perform a process of monitoring whether there is an anomaly in the processing apparatus 2 through the monitoring data transmitted from the sensor 3. In addition, even when the plurality of sensors 3 transmit different types of data, the condition monitoring apparatus 4, according to some example embodiments, may monitor the different types of data to determine a presence of the anomaly and/or the location of the anomaly. In addition, even when the plurality of sensors 3 simultaneously transmit the monitoring data, the condition monitoring apparatus 4 according to some example embodiments may monitor the monitoring data to determine a presence of the anomaly.

In the monitoring unit according to some example embodiments, the third decoder 233 described above may be omitted. The monitoring unit according to some example embodiments may include two decoders. Accordingly, in a training process of the monitoring unit according, the training process corresponding to the third decoder 233 as described above in FIGS. 5 to 8 may be omitted. The training process of such a monitoring unit may be same as or similar to in some respects to the training process discussed above in FIGS. 5 to 8 and will be best understood with reference thereto and a description thereof is omitted for the sake of brevity.

In addition, an anomaly score of the monitoring unit according to some example embodiments may be obtained based on Equation 8. In Equation 8, D1b_out may represent the first decoding data, and D2b_out may represent the second decoding data. In Equation 8, α and β may be parameters.

$$αD1b\_out + βD2b\_out \qquad [ Equation 8 ]$$

The monitoring process in the absence of the third decoder 233 may be same as or similar in some respects to the monitoring process described above in FIGS. 9 to 11, and therefore may be best understood with reference thereto, and a repeat description thereof is omitted for the sake of brevity.

Example embodiments as disclosed provide technical solutions to the technical problems discussed above by automatically performing a process of monitoring whether there is an anomaly in the processing apparatus 2 through the monitoring data transmitted from the sensor 3. The example embodiments provide several practical applications and technical advantages.

For example, example embodiments provide the practical application of monitoring different types of data transmitted by a plurality of sensors 3 of a plurality of processing apparatuses 2 to determine whether there is the anomaly and/or the location of the anomaly.

Because the condition monitoring apparatus 4 may monitor and analyze different types of data from different processing apparatuses 2, multiple operators (users) may not be needed to perform the monitoring and analysis. As a result, the example embodiments provide a cost effective and timesaving solution for determining an operational state of each processing apparatus and the location of any anomaly occurring in each processing apparatus. Thus, the example embodiments generally improve the technology related to monitoring an operational state of a processing apparatus used, for example, in semiconductor manufacturing.

While the condition monitoring apparatus, according to some example embodiments, is described with reference to semiconductor manufacturing, it will be understood that example embodiments disclosed herein are equally applicable to other technology fields where it may be advantageous to monitor an operational state of a processing or manufacturing apparatus or system.

As described herein, any devices, systems, modules, portions, units, controllers, circuits, and/or portions thereof according to any of the example embodiments, and/or any portions thereof (including, without limitation, the processing apparatus 2, the sensors 3, the condition monitoring apparatus 4, the preprocessor 5, the encoder 200, the decoders 231, 232, and 233, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A condition monitoring apparatus, comprising:
a memory configured to store a computer-readable program code; and
a processor configured to execute the computer-readable program code, wherein the computer-readable program code configures the processor to:
encode monitoring data received from at least one sensor to obtain a first mean and a first standard deviation,
sample the first mean and the first standard deviation to obtain a primary latent variable,
perform a first decoding operation to reconstruct the primary latent variable to obtain first decoding data,
encode the first decoding data to obtain a second mean and a second standard deviation,
sample the second mean and the second standard deviation to obtain a secondary latent variable, and
perform a second decoding operation to reconstruct the secondary latent variable to obtain second decoding data.

2. The condition monitoring apparatus of claim 1, wherein the processor is further configured to monitor a monitoring target based on an anomaly score that is based on the first decoding data and the second decoding data, and wherein the monitoring target is configured to transmit the monitoring data.

3. The condition monitoring apparatus of claim 2, wherein the anomaly score is defined by Equation below:
$$αD1b\_out + βD2b\_out , \qquad [ Equation ]$$
wherein in Equation, D1b_out is the first decoding data, D2b_out is the second decoding data, and α and β are parameters.

4. The condition monitoring apparatus of claim 2, wherein the processor is further configured to determine that an anomaly has occurred in the monitoring target in response to the anomaly score being greater than or equal to a predetermined value.

5. The condition monitoring apparatus of claim 2, wherein the processor is further configured to determine that an anomaly has occurred in the monitoring target in response to the anomaly score being greater than a predetermined value.

6. A condition monitoring apparatus, comprising:
a memory configured to store a computer-readable program code; and
a processor configured to execute the computer-readable program code, wherein the computer-readable program code configures the processor to:
encode monitoring data to obtain a primary latent variable,
perform a first decoding operation to reconstruct the primary latent variable to obtain first decoding data,
encode the first decoding data to obtain a secondary latent variable,
perform a second decoding operation to reconstruct the secondary latent variable to obtain second decoding data,
encode the second decoding data to obtain a tertiary latent variable, and
perform a third decoding operation to reconstruct the tertiary latent variable to obtain third decoding data.

7. The condition monitoring apparatus of claim 6, wherein the processor is further configured to monitor a monitoring target based on an anomaly score that is based on the first decoding data, the second decoding data, and the third decoding data, and wherein the monitoring target is configured to transmit the monitoring data.

8. The condition monitoring apparatus of claim 7, wherein the anomaly score is defined by Equation below:
$$αD1b\_out + βD2b\_out + γD3b\_out \qquad [ Equation ]$$
wherein in Equation, D1b_out is the first decoding data, D2b_out is the second decoding data, D3b_out is the third decoding data, and α, β, and γ are parameters.

9. The condition monitoring apparatus of claim 7, wherein the processor is further configured to determine that an anomaly has occurred in the monitoring target in response to the anomaly score being greater than or equal to a predetermined value.

10. The condition monitoring apparatus of claim 7, wherein the processor is further configured to determine that an anomaly has occurs in the monitoring target in response to the anomaly score being greater than a predetermined value.

11. The condition monitoring apparatus of claim 6, wherein the processor is configured to encode the monitoring data to obtain a mean and a standard deviation and sample the mean and the standard deviation to obtain the primary latent variable.

12. The condition monitoring apparatus of claim 11, wherein the processor is configured to sample the mean and the standard deviation by performing reparameterization trick of Equation below:
$$z = μ + {σ}^{2} \cdot ∈ \qquad [ Equation ]$$
wherein in Equation, z is a latent variable, μ is a mean, σ is a standard deviation, and ε is a noise sampled from a normal distribution with the mean of 0 and the standard deviation of 1.

13. The condition monitoring apparatus of claim 6, wherein the processor is further configured to encode the first decoding data to obtain a mean and a standard deviation, and sample the mean and the standard deviation to obtain the secondary latent variable.

14. The condition monitoring apparatus of claim 6, wherein the processor is further configured to encode the second decoding data to obtain a mean and a standard deviation, and sample the mean and the standard deviation to obtain the tertiary latent variable.

15. The condition monitoring apparatus of claim 6, wherein the monitoring data is received from a plurality of sensors, and the computer-readable program code includes sensor identification data that distinguishes and identifies the plurality of sensors transmitting the monitoring data.

16. A condition monitoring apparatus, comprising:
a memory configured to store a computer-readable program code; and
a processor configured to execute the computer-readable program code, wherein the computer-readable program code configures the processor to:
encode monitoring data received from at least one sensor into a first mean and a first standard deviation,
sample the first mean and the first standard deviation to obtain a primary latent variable,
perform a first decoding operation to reconstruct the primary latent variable to obtain first decoding data,
encode the first decoding data to obtain a second mean and a second standard deviation,
sample the second mean and the second standard deviation to obtain a secondary latent variable,
perform a second decoding operation to reconstruct the secondary latent variable to obtain second decoding data,
encode the second decoding data to obtain a third mean and a third standard deviation,
sample the third mean and the third standard deviation to obtain a tertiary latent variable,
perform a third decoding operation to reconstruct the tertiary latent variable to obtain third decoding data, and
calculate monitoring result data through an anomaly score that is based on to the first decoding data, the second decoding data, and the third decoding data.

17. The condition monitoring apparatus of claim 16, wherein the processor is further configured to output anomaly detection state data that indicates that an anomaly has occurred in a monitoring target in response to the anomaly score being greater than or equal to a predetermined value, and wherein the monitoring target is configured to transmit the monitoring data as the monitoring result data.

18. The condition monitoring apparatus of claim 16, wherein the processor is further configured to output normal confirmation data that indicates that an operational state of a monitoring target is normal in response to the anomaly score being less than a predetermined value, and wherein the monitoring target is configured to transmit the monitoring data as the monitoring result data.

19. The condition monitoring apparatus of claim 16, wherein the monitoring data are received from a plurality of sensors, and the computer-readable program code includes sensor identification data that distinguishes and identifies the plurality of sensors transmitting the monitoring data.

20. The condition monitoring apparatus of claim 19, wherein the processor is configured to identify a sensor of the plurality of sensors transmitting the monitoring data used to calculate the monitoring result data based on the sensor identification data.
